(19) United States
(12) Patent Application Publication
(10) Pub. No.: US 2005/0092379 A1
(43) Pub. Date: May 5, 2005

(54) Valve sealing flange

(75) Inventors: Jim Pfadt, Cambridge Springs, PA (US); Craig Brown, North East, PA (US); Duane Winnie, Fairview, PA (US); Brian Mayo, Erie, PA (US); Rick Carlson, Erie, PA (US)

Correspondence Address: BIRCH STEWART KOLASCH & BIRCH, PO BOX 747, FALLS CHURCH, VA, 22040-0747, US

(73) Assignee: NIAGARA PLASTICS LLC, Erie, PA (US)

(21) Appl. No.: 10/959,118

(22) Filed: Oct. 7, 2004

Related U.S. Application Data
(60) Provisional application No. 60/508,878, filed on Oct. 7, 2003.

(51) Int. Cl. F16L 35/00

(52) U.S. Cl. 137/800

(57) ABSTRACT

A valve sealing flange for sealing fluid ports in a valve is provided, comprising a flexible planar portion having first and second opposed surfaces, spaced-apart, elongated, tapered protrusions extending upwardly from the first surface of said sealing flange, the protrusions being configured and positioned on the surface of the planar portion to mate with fluid ports located within a side surface of a valve when the valve sealing flange is placed thereon to effect sealing of the ports, and spaced-apart protrusions extending from the second surface of thesealing flange, the protrusions being of such configuration and spacing to support the sealing flange in a substantially level position when attached to the valve.

### PRIORITY CLAIM

This Non-provisional application claims priority under 35 U.S.C. § 119(e) on U.S. Provisional Application No. 60/508,878 filed on Oct. 7, 2003, the entire contents of which are hereby incorporated by reference.

### BACKGROUND OF THE PRESENT INVENTION

The present invention is directed to a valve sealing flange.

Various types of valves are well known in the marketplace. Examples of valves are directional valves, non-directional valves, and servo valves. A common aspect of these valves is that they provide a flow path for fluid such as hydraulic fluid by means of fluid ports. For example, directional control valves control the flow of hydraulic fluid for hydraulic cylinders. The valve provides a flow path from the pump to the cylinders, as well as a return path from the cylinders to the fluid reservoir.

During manufacture, it is commonplace for these valves to be tested for purposes of quality control. Hydraulic fluid is present in the valves during the tests. Once approved for sale, the valves are packaged and shipped to the customer. However, any residual hydraulic fluid which remains in the valves tends to leak from the fluid ports of the valve during shipment. Such leakage poses an inconvenience in that it results in an oily package and is a disadvantage to the customer upon handling.

Prior attempts to plug the fluid ports to minimize or prevent leakage of the hydraulic fluid have not been successful. For instance, it is commonplace to place a rigid plate over the face of the valve which covers the fluid ports but does not seal the ports.

### SUMMARY OF THE INVENTION

In an effort to overcome the disadvantages and failures of the prior art in connection with the sealing of the fluid ports of the valves prior to and during shipment to the customer, the novel sealing flange of the present invention is provided which comprises:

a flexible planar portion having first and second opposed surfaces,

spaced-apart, elongated, tapered protrusions extending upwardly from said first surface of said sealing flange, said protrusions being configured and positioned on said surface of said planar portion to mate with fluid ports located within a side surface of a valve when said valve sealing flange is placed thereon to effect sealing of said ports, and

spaced-apart protrusions extending from said second surface of said sealing flange, said protrusions being of such configuration and spacing to support said sealing flange in a substantially level position when attached to said valve.

### BRIEF DESCRIPTION OF THE INVENTION

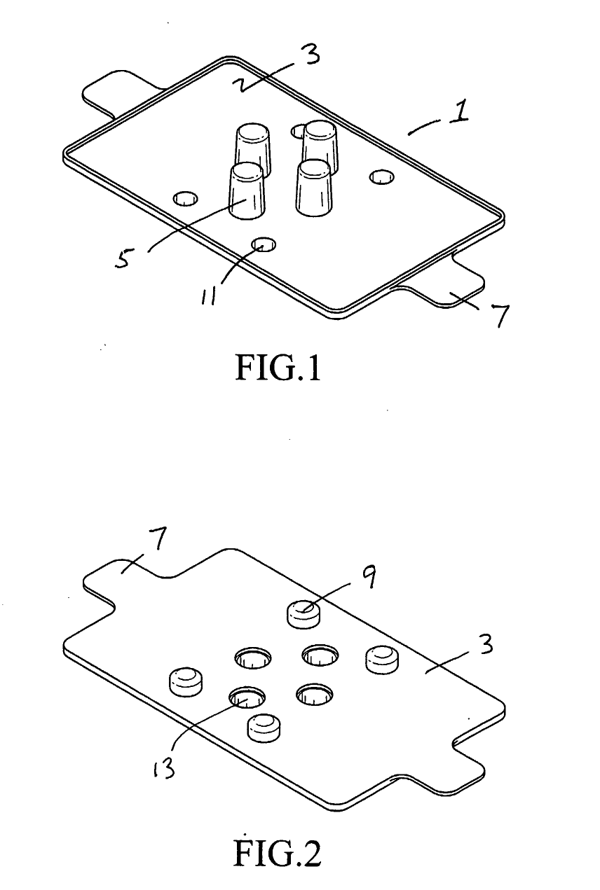

FIG. 1 depicts a top view of the novel sealing flange of the present invention.

FIG. 2 depicts a bottom view of the novel sealing flange of the present invention.

### DETAILED DESCRIPTION OF THE INVENTION

The sealing flange is discussed in relation to FIGS. 1 and 2 of the present invention.

The sealing flange 1 of the present invention is comprised of a relatively planar portion 3 having finger tabs 7 and elongated, tapered protrusions 5 extending upwardly therefrom. Indentations 11 also reside in the top surface of the sealing flange. The configuration of the planar portion of the sealing flange is sized to permit a side surface of the valve to be placed thereupon. The protrusions 5 are configured and positioned to mate with corresponding fluid ports within the side of the valve which is placed on the planar surface. Thus, when the valve is placed on the planar surface, the respective protrusions are forced into and seated within fluid ports in the side of the valve. The fluid ports are thus caused to be sealed due to the presence of the protrusions in the fluid port openings. Due to the tapered configuration of the protrusions, the protrusions achieve a tight fit within the fluid ports.

It should be apparent that the configuration of the protrusions depicted in FIG. 1 is specific to a valve having matching configurations for fluid ports present therein. Hence, the present invention is not directed to any specific configuration or location of the protrusions on the planar portion 3, as the specific configuration and location of the protrusions is determined by the configuration required to permit engagement with and sealing of the fluid ports on any valve of interest.

FIG. 2 depicts the reverse side of the sealing flange. Protrusions 9 serve as leveling means for the valve once the sealing flange is assembled with the valve. That is, the sealed valve is placed on the assembly line with the bottom of the sealing flange in contact with, for example, a conveyor belt. The protrusions 9 thus serve to maintain the assembled valve in an upright position while on the conveyor belt after the sealing flange has been attached to the valve.

Finger tabs 7 are not essential to practice of the present invention but assist in removal of the sealing flange from engagement with the control valve when the control valve is ready for use. The finger tabs may be positioned at any location along the periphery of the sealing flange, and more or less than two tabs may be used.

Holes 11, 13 are also not essential to practice of the invention but are merely the result of the molding process during manufacture of the sealing flange. It is obvious that the presence of the holes may be avoided if an alternate means of manufacture is employed to provide for the presence of the protrusions 5, 9.

The sealing flange may be comprised of any suitable material which permits adequate sealing engagement with fluid ports of the valve and is chemically resistant to contact with hydraulic fluid. For example, a polymeric material comprised of a polyolefin such as polyethylene (either low or high density polyethylene) may be used with advantage. Such material should be sufficiently flexible to conform to the configuration of the valve to which it is attached. One skilled in the art can readily determine the type of material that may be used with success upon practice of the present invention. A typical thickness of the planar portion of the sealing flange is on the order of 0.035 inch. Of course, the thickness may vary depending upon the type of material employed and the degree of flexibility desired.

1. A valve sealing flange for sealing fluid ports in a valve, comprising
a flexible planar portion having first and second opposed surfaces,
spaced-apart, elongated, tapered protrusions extending upwardly from said first surface of said sealing flange, said protrusions being configured and positioned on said surface of said planar portion to mate with and be positioned within fluid ports located within a side surface of a valve when said valve sealing flange is placed thereon to effect sealing of said ports, and
spaced-apart protrusions extending from said second surface of said sealing flange, said protrusions being of such configuration and spacing to support said sealing flange in a substantially level position when attached to said valve.

2. The valve sealing flange of claim 1, further including at least one finger tab extending from the periphery of said flange to assist in removal of said flange from engagement with a valve.

3. The valve sealing flange of claim 1, wherein said flange is comprised of a flexible, polymeric material.

4. The valve sealing flange of claim 3, wherein said material comprises a polyolefin.

5. The valve sealing flange of claim 4, wherein said polyolefin is polyethylene.

6. The valve sealing flange of claim 1, wherein said protrusions extending from said second surface are substantially cylindrical in configuration.
